(19) United States
(12) Patent Application Publication
(10) Pub. No.: US 2021/0374770 A1
(43) Pub. Date: Dec. 2, 2021

(54) MEASURING SUCCESSFUL INSIGHT TOOL INTERACTIONS

(71) Applicant: BUSINESS OBJECTS SOFTWARE LTD., Dublin (IE)

(72) Inventors: Anirban Banerjee, Kilcullen (IE); Robert McGrath, Ranelagh (IE); Malte Christian Kaufmann, Clonskeagh (IE); Eoin Goslin, Dublin (IE); Esther Rodrigo Ortiz, Castleforbes (IE)

(21) Appl. No.: 16/890,430

(22) Filed: Jun. 2, 2020

(51) Int. Cl. G06Q 30/02; H04L 29/08

(52) U.S. Cl. CPC G06Q 30/0201; G06F 3/0482; H04L 67/22

(57) ABSTRACT

The present disclosure involves systems, software, and computer implemented methods for measuring successful interactions with an insight tool. One example method includes receiving a request for insights for a data point of a data visualization. Insights for the data point are identified and presented in an insights interface in a user session. User interactions with the insights interface are tracked during the user session. A determination is made that the user session has completed. At least one insights success rule is identified for determining whether user sessions with the insights interface are successful. The one or more insights success rules are evaluated to determine whether the user session was successful. In response to determining that the user session was successful, a measure of success for the user session is recorded. In response to determining that the user session was unsuccessful, a measure of failure is recorded for the user session.

### TECHNICAL FIELD

The present disclosure relates to computer-implemented methods, software, and systems for measuring successful interactions with an insight tool.

### BACKGROUND

An analytics platform can help an organization with decisions. Users of an analytics application can view data visualizations, see data insights, or perform other actions. Through use of data visualizations, data insights, and other features or outputs provided by the analytics platform, organizational leaders can make more informed decisions.

### SUMMARY

The present disclosure involves systems, software, and computer implemented methods for measuring successful interactions with an insight tool. An example method includes: receiving a request for insights for a first data point of a data visualization; automatically identifying at least one insight for the first data point; presenting the at least one insight in an insights user interface in a first user session; tracking user interactions with the insights user interface during the first user session; determining that the first user session with the insights user interface has completed; identifying at least one insights success rule for determining whether user sessions with the insights user interface are successful; evaluating the at least one insights success rule to determine whether the first user session with the insights user interface was successful; in response to determining that the first user session was successful, recording a first measure of success for the first user session; and in response to determining that the first user session was unsuccessful, recording a first measure of failure for the first user session.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for measuring successful interactions with an insight tool.

FIG. 2 illustrates an example user interface for invoking a smart insights tool.

FIG. 3 illustrates an example insights panel.

FIG. 4 illustrates expansion of an insight in an insights panel.

FIG. 5 illustrates performing an action on an insight in an insights panel.

FIG. 6 illustrates an example usage tracking metrics dashboard.

FIGS. 7A-7B are swim lane diagrams of an example method for measuring interactions with an insight tool.

FIG. 8 is a flowchart of an example method for measuring successful interactions with an insight tool.

### DETAILED DESCRIPTION

Usage tracking, such as counting application or tool invocations, can be used to enable application stakeholders to understand application or tool usage. For example, an insights tool can include functionality to count instances of users opening the insight tool. However, stakeholders may be more interested in more refined and intelligent tracking that tracks, for example, successful interactions with the insight tool. Simple invocation counts may not accurately measure successful interactions. Simple counting may count accidental invocations of the insight tool, for example. Simple counting does not reflect a split of successful interactions vs. unsuccessful interactions.

Successful interactions can be meaningful (e.g., rather than accidental) uses of a tool, for example. Meaningful uses can be uses of a tool that happen beyond simple invocation of the tool. For instance, a use of the tool can be meaningful if the user actually interacts with one or more insights after the tool is opened. If the user doesn't act with any insights, the invocation may have been accidental, or the insights themselves may not have been meaningful or interesting to the user. Interacting with one or more insights is one example of a rule for identifying a meaningful interaction. Other types of rules can be configured that define what types of tool use correspond to meaningful interactions.

Tracking meaningful interactions can provide numerous advantages. For instance, tracking meaningful interactions can enable identifying a split of successful vs. unsuccessful interactions of the insight tool, which can be valuable information for stakeholders. Additionally, more refined tracking can enable capturing of other insights. For instance, usage time for (e.g., time spent on) the insight tool can be determined. Stakeholders can also see user action sequences that are typically or most often performed after opening of the insight tool. Most popular insights can be identified, for example. User behavior tracking can be performed while maintaining user anonymity.

Different insights can be provided to different insight providers. Different stakeholders may provide (e.g., develop, distribute) different insights that can be incorporated into the insight tool. Usage tracking can be performed per insight provider and provider-specific tracking information can be provided to respective providers. A usage tracking framework can enable existing and future insights to be tracked, using the framework.

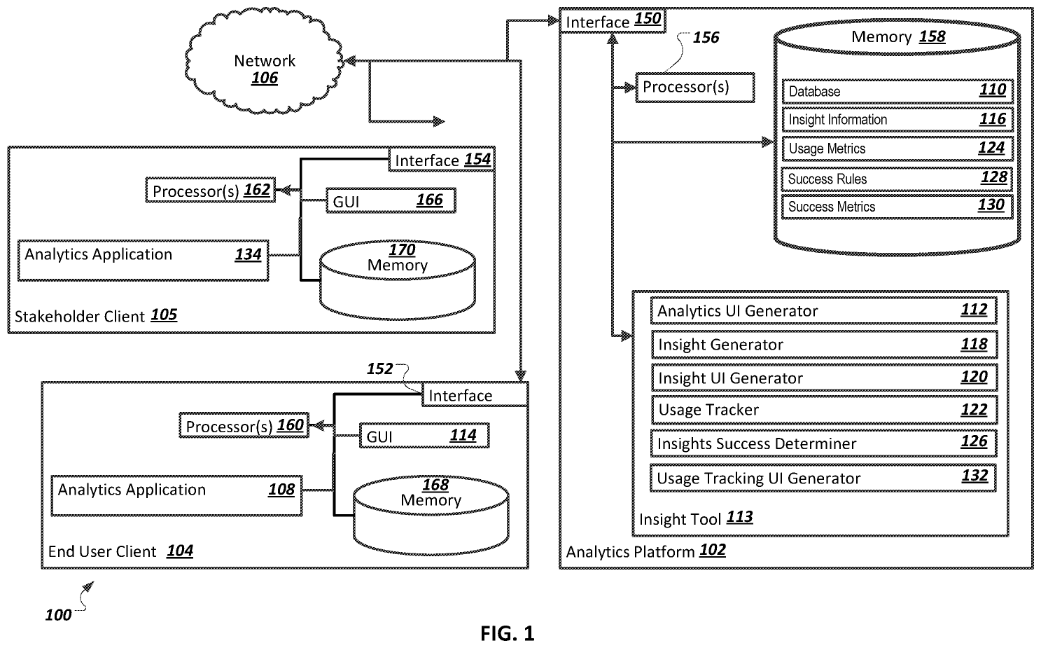

FIG. 1 is a block diagram illustrating an example system 100 for measuring successful interactions with an insight tool. Specifically, the illustrated system 100 includes or is communicably coupled with an analytics platform 102, a client device 104, a system stakeholder client device 105, and a network 106. Although shown separately, in some implementations, functionality of two or more systems or servers may be provided by a single system or server. In some implementations, the functionality of one illustrated system, server, or component may be provided by multiple systems, servers, or components, respectively.

The analytics platform 102 can be a software as a service (SaaS) business intelligence (BI) platform, for providing analytics features to users. A user of the end user client device 104 can use an analytics application 108 to access the analytics platform 102, for example. The analytics platform 102 can enable access to server or cloud-based analytics applications that enable data visualization of information in a database 110, for instance. Analytics can be provided to users, to enable users visualize and understand data in the database 110. For instance, an analytics UI generator 112 of an insight tool 113 can generate and provide the analytics application 108. The user can use the analytics application 108 to view different data visualizations on a GUI (Graphical User Interface) 114, for instance.

While viewing a data visualization or a data point, the user may request an insights tool so that additional insights (e.g., insight information 116) for a data point or displayed item, generated by an insight generator 118, can be presented in the analytics application 108. Insights can be displayed in an insights panel, for example. An insight UI generator 120 can generate the panel and presentable items (e.g., selectable insights), and provide presentable insight information to the analytics application 108.

The user may interact with presented insights, such as to expand, copy, share, print, or otherwise interact with a presented insight. As another example, the user may close the insights panel without performing any actions on presented insights. A usage tracker 122 can track insight panel/tool invocations and any interactions that occur after the insights panel is displayed, as usage metrics 124. Interactions can be tracked on a session basis (e.g., from panel opening to panel closing).

Analytics platform stakeholders may have goals to make the analytics application 108 engaging and user friendly. Accordingly, stakeholders may desire to know not only how frequently certain features (such as the insights panel) are used, but also usefulness/success measures for the feature(s). For instance, an insight tool product owner may desire to track user actions with the insight tool so as to receive metrics that measure insight relevance, success, or failure.

An insights success determiner 126 can access success rules 128 that can be evaluated to determine whether user sessions with the insights tool are successful. Rules can be insight-specific or can apply to the tool itself. A rule can specify that presentation of the smart insights tool is successful if the user interacts with at least one presented insight. As another example, a rule can specify that presentation of insights of a particular type (e.g., top contributors to a dimension) are successful if the user at least expands an insight of that particular type. Success rule 128 evaluation can result in various success metrics 130.

A usage tracking UI generator 132 can generate a tracking dashboard interface, for viewing success metrics 130 (and, for example, usage metrics 124). The tracking dashboard can be provided to the stakeholder client device 105, for presentation in an analytics (or administrative) application 134, that is viewable by product stakeholder(s), for example. Stakeholders can consider how the information presented in the dashboard may affect future activities or development related to the analytics platform 102, for example.

As used in the present disclosure, the term “computer” is intended to encompass any suitable processing device. For example, although FIG. 1 illustrates a single analytics platform 102, a single end-user client device 104, and a single system stakeholder client device 105, the system 100 can be implemented using a single, stand-alone computing device, two or more servers 102, or multiple client devices. Indeed, the analytics platform 102 and the client devices 104 and 105 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the analytics platform 102 and the client devices 104 and 105 may be adapted to execute any operating system, including Linux, UNIX, Windows, Mac OS®, Java™, Android™, iOS or any other suitable operating system. According to one implementation, the analytics platform 102 may also include or be communicably coupled with an e-mail server, a Web server, a caching server, a streaming data server, and/or other suitable server.

Interfaces 150, 152, and 154 are used by the analytics platform 102, the end-user client device 104, and the system stakeholder client device 105, respectively, for communicating with other systems in a distributed environment—including within the system 100—connected to the network 106. Generally, the interfaces 150, 152, and 154 each comprise logic encoded in software and/or hardware in a suitable combination and operable to communicate with the network 106. More specifically, the interfaces 150, 152, and 154 may each comprise software supporting one or more communication protocols associated with communications such that the network 106 or interface's hardware is operable to communicate physical signals within and outside of the illustrated system 100.

The analytics platform 102 includes one or more processors 156. Each processor 156 may be a central processing unit (CPU), a blade, an application specific integrated circuit (ASIC), a field-programmable gate array (FPGA), or another suitable component. Generally, each processor 156 executes instructions and manipulates data to perform the operations of the analytics platform 102. Specifically, each processor 156 executes the functionality required to receive and respond to requests from the end-user client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The analytics platform 102 includes memory 158. In some implementations, the analytics platform 102 includes multiple memories. The memory 158 may include any type of memory or database module and may take the form of volatile and/or non-volatile memory including, without limitation, magnetic media, optical media, random access memory (RAM), read-only memory (ROM), removable media, or any other suitable local or remote memory component. The memory 158 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the analytics platform 102.

The end-user client device 104 and the system stakeholder client device 105 may each generally be any computing device operable to connect to or communicate with the analytics platform 102 via the network 106 using a wireline or wireless connection. In general, the end-user client device 104 and the system stakeholder client device 105 each comprise an electronic computer device operable to receive, transmit, process, and store any appropriate data associated with the system 100 of FIG. 1. The end-user client device 104 and the system stakeholder client device 105 can each include one or more client applications, including the analytics application 108 or the analytics application 134, respectively. A client application is any type of application that allows the end-user client device 104 or the system stakeholder client device 105 to request and view content on a respective client device. In some implementations, a client application can use parameters, metadata, and other information received at launch to access a particular set of data from the analytics platform 102. In some instances, a client application may be an agent or client-side version of the one or more enterprise applications running on an enterprise server (not shown).

The client device 104 and the system stakeholder client device 105 respectively include processor(s) 160 or processor(s) 162. Each processor 160 or 162 included in the end-user client device 104 or the system stakeholder client device 105 may be a central processing unit (CPU), an application specific integrated circuit (ASIC), a field-programmable gate array (FPGA), or another suitable component. Generally, each processor 160 or 162 included in the end-user client device 104 or the system stakeholder client device 105 executes instructions and manipulates data to perform the operations of the end-user client device 104 or the system stakeholder client device 105, respectively. Specifically, each processor 160 or 162 included in the end-user client device 104 or the system stakeholder client device 105 executes the functionality required to send requests to the analytics platform 102 and to receive and process responses from the analytics platform 102.

The end-user client device 104 and the system stakeholder client device 105 are each generally intended to encompass any client computing device such as a laptop/notebook computer, wireless data port, smart phone, personal data assistant (PDA), tablet computing device, one or more processors within these devices, or any other suitable processing device. For example, the end-user client device 104 and/or the system stakeholder client device 105 may comprise a computer that includes an input device, such as a keypad, touch screen, or other device that can accept user information, and an output device that conveys information associated with the operation of the analytics platform 102, or the respective client device itself, including digital data, visual information, or the GUI 114 or a GUI 166, respectively.

The GUIs 114 and 166 interface with at least a portion of the system 100 for any suitable purpose, including generating a visual representation of the analytics application 108 or the analytics application 134, respectively. In particular, the GUI 114 and/or the GUI 166 may be used to view and navigate various Web pages. Generally, the GUI 114 and the GUI 166 each provide a respective user with an efficient and user-friendly presentation of business data provided by or communicated within the system. The GUI 114 and the GUI 166 may each comprise a plurality of customizable frames or views having interactive fields, pull-down lists, and buttons operated by the user. The GUI 114 and the GUI 166 each contemplate any suitable graphical user interface, such as a combination of a generic web browser, intelligent engine, and command line interface (CLI) that processes information and efficiently presents the results to the user visually.

Memory 168 and memory 170 included in the end-user client device 104 or the system stakeholder client device 105, respectively, may each include any memory or database module and may take the form of volatile or non-volatile memory including, without limitation, magnetic media, optical media, random access memory (RAM), read-only memory (ROM), removable media, or any other suitable local or remote memory component. The memory 168 and the memory 170 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the associated client device.

There may be any number of end-user client devices 104 and/or stakeholder client devices 105 associated with, or external to, the system 100. For example, while the illustrated system 100 includes one end-user client device 104, alternative implementations of the system 100 may include multiple end-user client devices 104 communicably coupled to the analytics platform 102 and/or the network 106, or any other number suitable to the purposes of the system 100. Additionally, there may also be one or more additional end-user client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the end-user client device 104 and the system stakeholder client device 105 may be described in terms of being used by a single user, this disclosure contemplates that many users may use one computer, or that one user may use multiple computers.

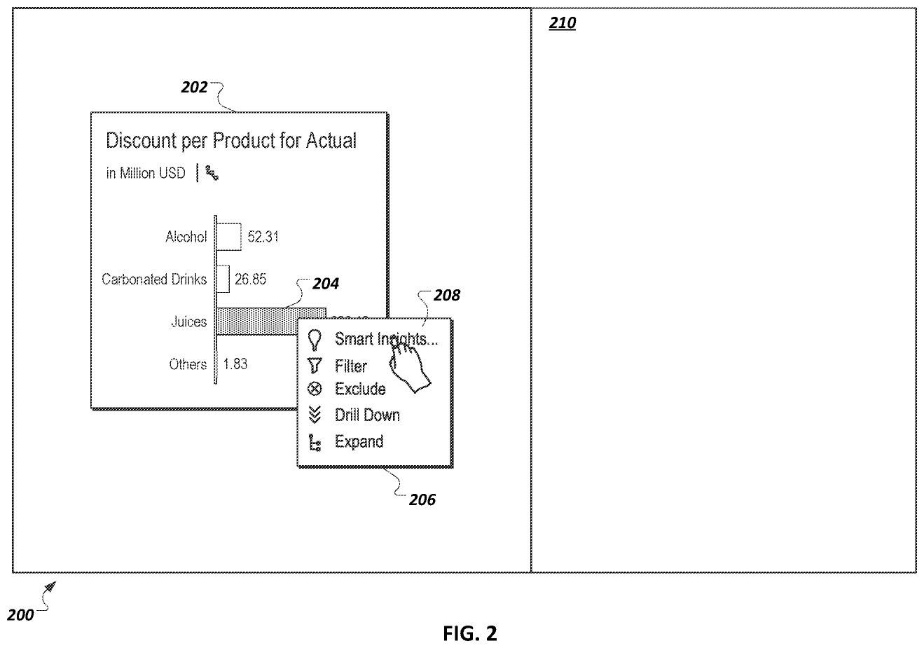

FIG. 2 illustrates an example user interface 200 for invoking a smart insights tool. A smart insights tool can be invoked for a data point. For example, the user interface 200 includes a chart 202, and the user can select an item 204 on the chart (relating to a juices product) and, for example, bring up a context menu 206 (e.g., using a “right click” or some other input) and select a smart insights item 208. Smart insights can enable a user to view insights about a particular data point that might not be evident in a first presentation of the data point. In response to selection of the smart insights item 208, insights can be displayed in an insights area 210 (e.g., in a defined area or in a panel that is displayed, e.g., at the edge or on top of the user interface 200).

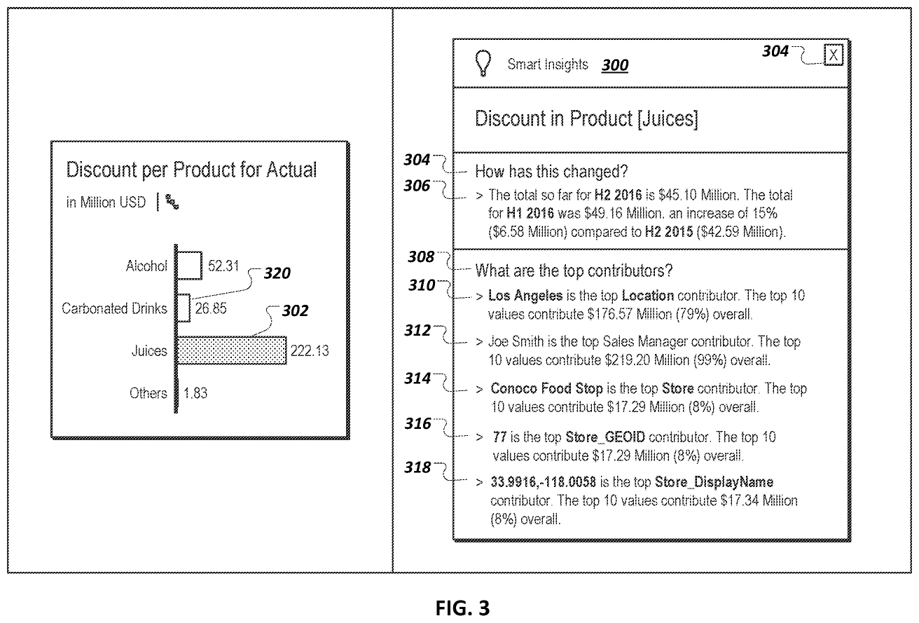

FIG. 3 illustrates an example insights panel 300. The insights panel 300 can be displayed in response to an invocation of a smart insights tool for a data point, such as a product juices data point 302. Different types of insights can be displayed in the insights panel 300. For example, a smart detects insight category 304 can include insights, including a smart detect insight 306, that provide information about a variation of measure values over time. Smart detect insights can provide information indicating which time periods may be the most interesting to the user, with respect to the selected data point.

As another example, a top contributors category 308 includes top contributor insights 310, 312, 314, 316, and 318 that each provide information regarding a measure value with respect to different dimensions/perspectives in a model, including indications of which dimension member(s) contributed most to the measure value. For example, the top contributor insights 310, 312, 314, 316, and 318 indicate which location, sales manager, store, store geo identifier, and store display name values contributed the most to data entries that included the product juice.

Usage tracking metrics can include a metric that counts openings of the insights panel 300. As mentioned, stakeholders may want more detailed tracking. Counting tool invocations can be important, but the user may have opened the insight panel 300 by mistake. For example, the user may have accidentally invoked the smart insights tool or may have invoked the tool for an unintended data point (e.g., the user may have instead meant to see insights related to a carbonated drinks data point 320).

Successful (to the user) use of the insights panel 300 can be defined as the user interacting with one or more insights after the insights panel 300 has been displayed. If the user selects a close item 304 before interacting with any insights, a tool invocation may be incremented, but a successful use count can remain the same (e.g., since closing without interaction can indicate an unsuccessful use of the tool). An unsuccessful invocation of the smart insights tool can be when insights are displayed but are not interesting enough for the user to further interact with the insight(s).

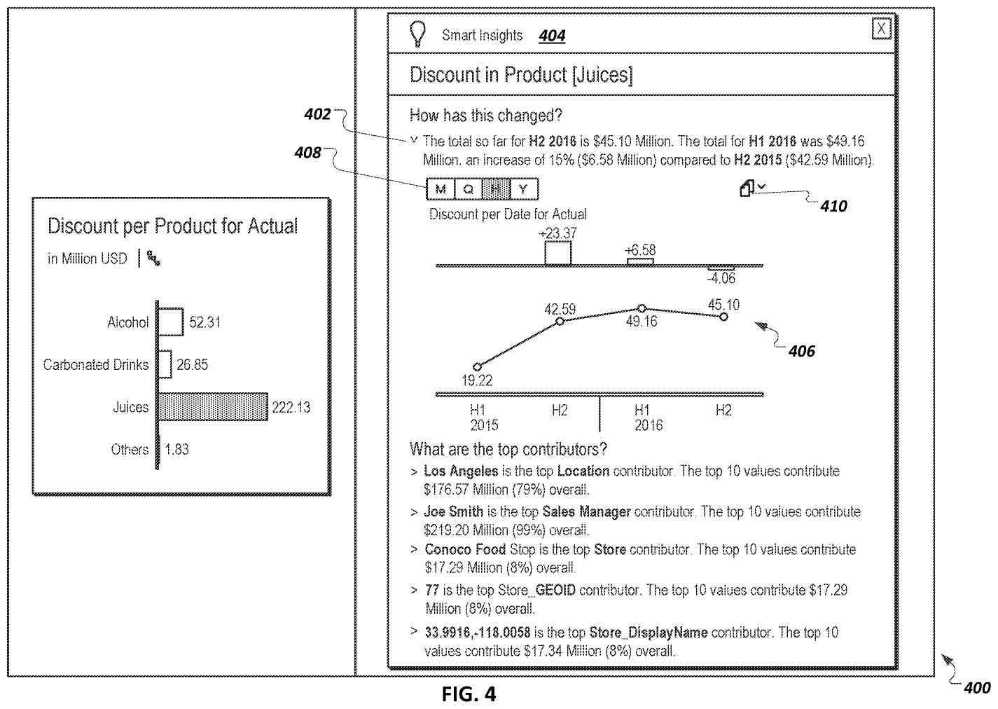

FIG. 4 illustrates expansion of an insight in an insights panel. The user has expanded a smart detect insight 402 in an insights panel 404. In response, a successful interaction can be recorded for the smart detect insight 402, if a rule for smart detect insights specifies that expanding a smart detect insight constitutes success. Similarly, if a rule for the smart insight tool itself specifies that interacting with at least one insight constitutes success, a successful interaction can be recorded for the smart insights tool.

Another type of rule may specify that success for a smart detect insight occurs if the user interacts with displayed detail of an expanded smart detect insight. For instance, if the user interacts with a graph 406, by zooming the graph 406, copying the graph 406, selecting a time period control 408 for the graph 406, etc., then a successful interaction with the smart detect insight 402 can be recorded. As another example, a successful interaction may be recorded if the user performs an action with the smart detect insight 402 by selecting a menu 410. The menu 410 can enable downloading, copying, sharing, or publishing the smart detect insight 402, for example.

In some implementations, all actions with all presented insights are tracked, regardless of whether those actions contribute to success or whether success has already occurred. For example, success with both a particular insight may be occur (and be recorded) after a first interaction with a first insight. However, additional interactions with the insight and other interactions with other insights can be still be recorded. Accordingly, if rule definitions for success are modified, success metrics can be regenerated based on reevaluation of the modified rules, using the recording action history.

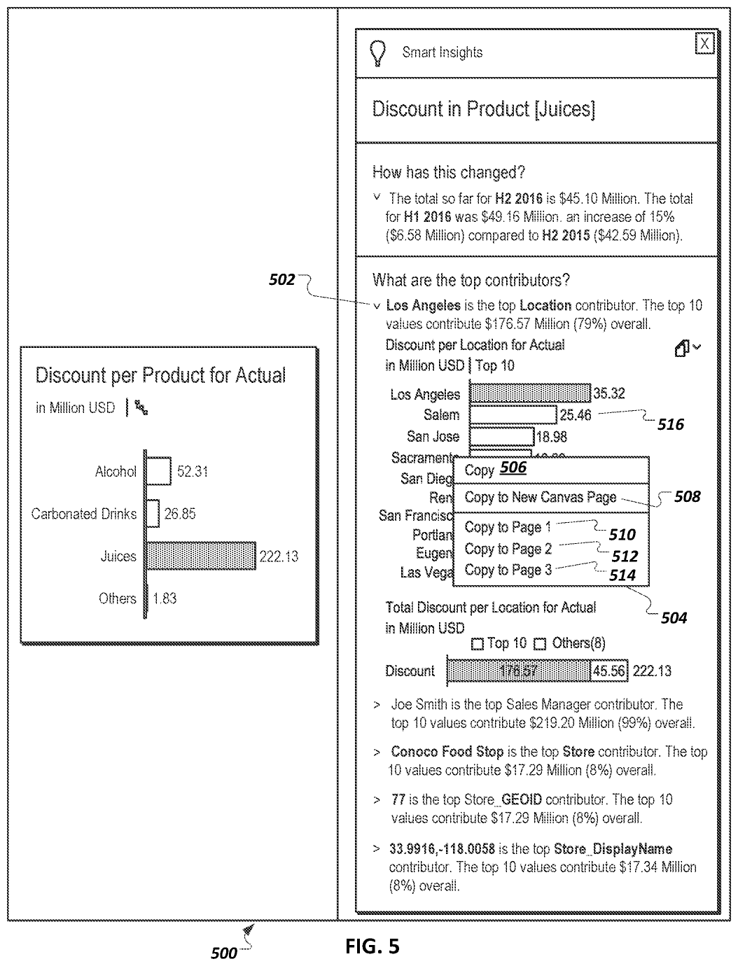

FIG. 5 illustrates performing an action on an insight in an insights panel. A user has expanded a top contributor insight 502. Expanding the top contributor insight 502 can result in a recording of a successful interaction with the insight tool and a recording of a successful interaction with the top contributor insight 502. Metric(s) regarding the top contributor insight 502 can be provided to an insight provider (e.g., a developer) who provides the top contributor insight 502.

Other actions can be performed on an insight and can result in a tracking of a successful interaction (with the insight and/or with the insight tool). For instance, the user can bring up a context menu 504 that includes a copy item 506, a copy to new canvas page item 508, and copy to page items 510, 512, and 514. Selection of any of the items on the context menu 504 can result in a recording of a successful interaction (with the insight tool and/or with a selected insight).

Other actions can be recorded and tracked. For instance, a user can, while looking at a data point presented for a first insight, provide a user input that requests a secondary smart insight analysis to be performed on the data point presented for the first insight. For instance, the user can right click on a Salem location item 516 presented in the top contributor insight 502 and select a menu item to request new insight(s) for the Salem location item 516. The insight tool can refresh, to show the new insights. Presenting the new insights can be treated as a new invocation of the insights tool, and success of the new invocation can be measured. For instance, a successful interaction can be recorded if the user interacts with any of the new insights presented in a refreshed view of the insights tool.

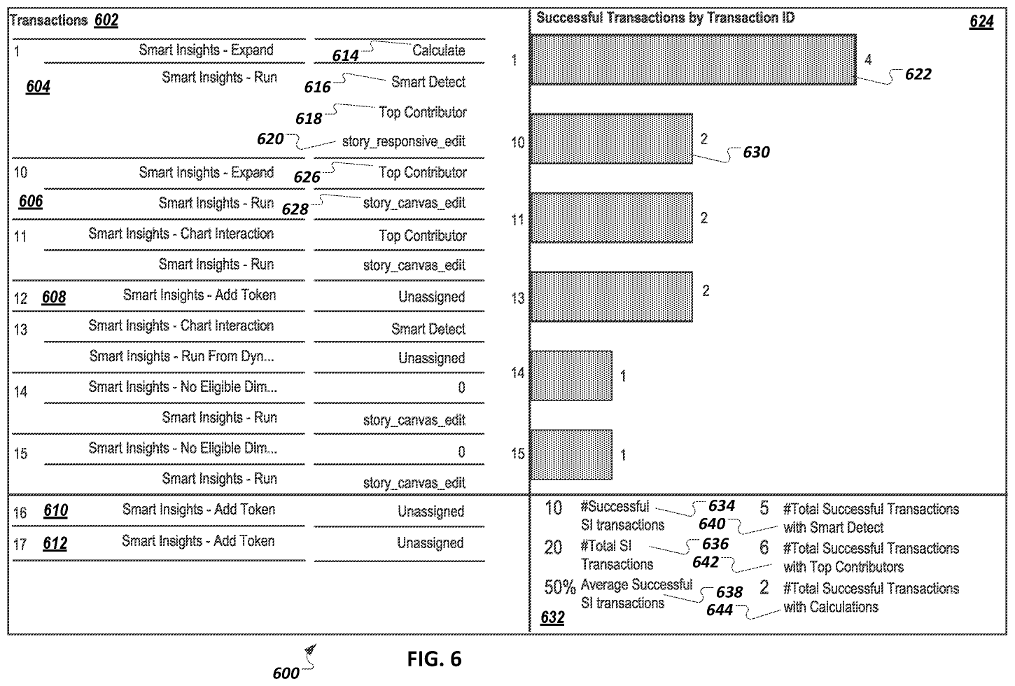

FIG. 6 illustrates an example usage tracking metrics dashboard 600. The dashboard 600 can be presented to stakeholder(s) of the smart insight tool, for example. Stakeholders can include developers or other stakeholders of the smart insight tool, developers or other stakeholders of particular insight providers, or other stakeholders. Metrics shown in the dashboard 600 can also be provided automatically to another system, for automatic processing by the other system.

A transactions area 602 includes entries that display transaction and associated action information for invocations of the smart insights tool. Each transaction can have a transaction identifier (ID). For instance, entries 604, 606, 608, 610, and 612 correspond to transactions with transaction IDs of one, ten, twelve, sixteen, and seventeen, respectively. The transactions area 602 can be scrollable (e.g., more transactions may have occurred other than those displayed). Additionally, in some implementations, the transactions area 602 can be filtered, by time period, action type, or by other types of filters.

Each transaction corresponds to an invocation of the smart insights tool. Each entry in the transactions area 602 lists indications of any insight-related action(s) that may have occurred during a smart insights tool session that begins with the invocation and ends when the smart insights tool is closed. For example, the entry 604 includes indications 614, 616, 618, and 620 of calculate insight expansion, smart detect insight expansion, top contributor insight expansion, and a responsive edit action, respectively. Correspondingly, a successful transactions count of four 622 is displayed for the transaction ID one in a successful transactions area 624. As another example, the entry 606 includes indications 626 and 628 for a top contributor insight expansion and a story canvas edit action (e.g., editing of a story canvas to include insight information), respectively. Correspondingly, a successful transactions count of two 630 for the transaction ID ten is displayed in the successful transactions area 624.

Some entries in the transaction area 602 correspond to unsuccessful transactions for which no action occurred after a smart insights panel was displayed. For instance, the entries 608, 610, and 612, for transaction IDs of twelve, sixteen, and seventeen, respectively, correspond to unsuccessful transactions. Accordingly, transaction IDs twelve, sixteen, and seventeen are not displayed in the successful transactions area 626.

A summary area 632 presents success metrics. For instance, a successful smart insights transactions metric 634 indicates that ten successful smart insight tool invocations have occurred (e.g., corresponding to satisfaction of a success rule, such as at least one action occurring before the smart insights tool is closed). A total smart insights tool transaction count 636 indicates that twenty transactions have occurred (e.g., since a particular time point or according to an enabled filter). A success percentage metric 638 indicates that fifty percent of smart insight tool invocations have been successful.

Insight-specific metrics can be calculated and displayed. For instance, metrics 640, 642, and 644 indicate that there have been five, six, and two successful interactions with smart detect, top contributor, and calculation insights, respectively. A sum (e.g., eleven) of the metrics 640, 642, and 644 is more than the total smart insights tool transaction count 636 often since a user may interact with more than one insight during a single smart insights tool session.

Other types of metrics can be computed and displayed in the dashboard 600. For example, an Average Time Spent on Smart Insights Panel (Open to Close) metric can track how much time users spend on average with a smart insight panel. As another example, a Smart Insight Failures metric can be displayed (e.g., equal to the total smart insights tool transaction count 636 minus the successful smart insights transactions metric 634).

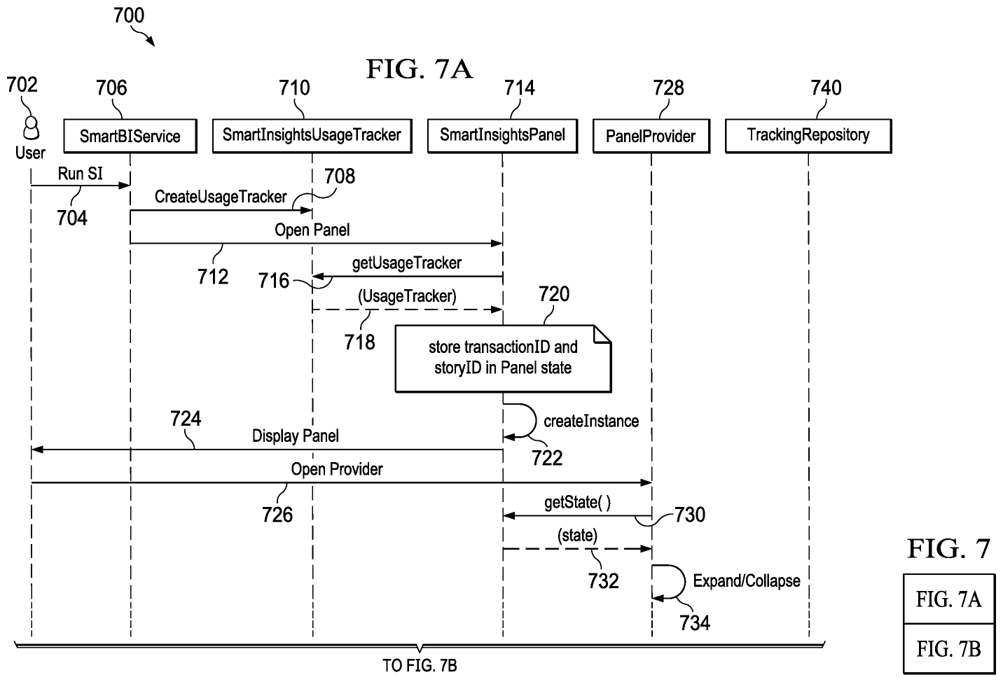

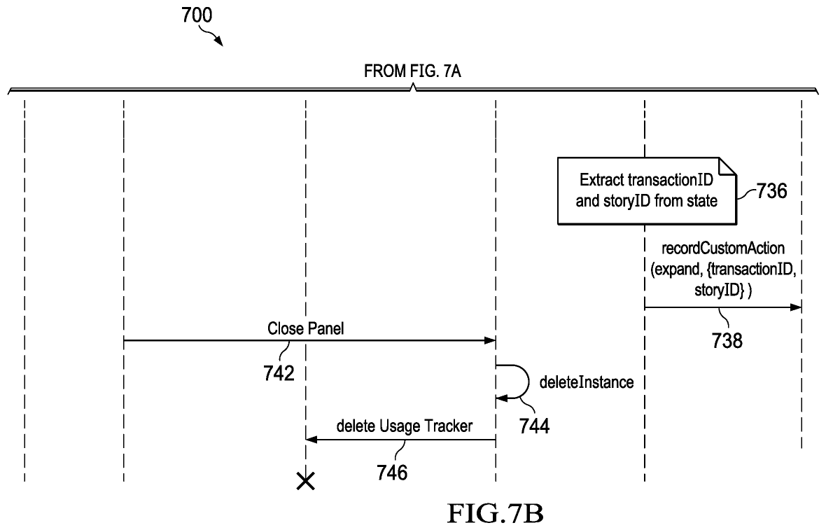

FIGS. 7A-7B are swim lane diagrams of an example method 700 for measuring interactions with an insight tool. A user 702 submits a request 704 to invoke a smart insights (SI) tool. The request 704 is received by a smart business intelligence (BI) service 706. The smart BI service 706 sends a request 708 to a smart insights usage tracker 710 to create a usage tracker object. The smart BI service 706 sends a request 712 to a smart insight panel class 714 to open a smart insights panel for the user 702.

The smart insights panel class 714 sends a request 716 to the smart insights usage tracker 710 to obtain a reference to a usage tracker instance. The smart insights usage tracker 710 sends a response 718 to the smart insights panel class 714 that includes (or refers to) the requested usage tracker instance.

The response 718 can include a transaction identifier that the smart insights usage tracker 710 generates in response to the request 708. The transaction identifier is a unique identifier associated with the current invocation of the smart insights panel. The transaction identifier can be created by any of the smart BI service 706, the smart insights usage tracker 710, or the smart insights panel class 714.

A transaction identifier can be used to group insight interactions stemming from a same invocation of the insight tool. Every action taken after the opening of the insights panel can have a same transaction identifier. Different recorded actions on insight(s) sharing the same transaction identifier can indicate that a single user interacted with the referenced insights in a single user session. Mapping of the a transaction identifier to actions can be halted when the insights panel is closed, and a new transaction identifier can be generated for a next opening of the insights panel.

The smart insights panel class 714 can store state information 720, including the transaction identifier and a story identifier, in a panel state area. The story identifier is an identifier of a story container. A story container can include user dashboards or user pages, for example.

At 722, the smart insights panel class 714 creates a smart insights panel instance, which results, e.g., at 724, of a display of a smart insights panel for the user 702. At 726, the user performs an open (e.g., expansion) user input on an insight on the displayed smart insights panel.

A panel provider 728 that provides the insight sends a request 730 to the smart insights panel class 714 for state information (e.g., transaction identifier and story identifier information). The smart insights panel class 714 sends a response 732 that includes the requested state (e.g., a transaction identifier and a story identifier).

The panel provider 728 performs an expand/collapse method 734 in response to the open user input performed on the insight. The panel provider 728 can generate (or retrieve) insight detail, for presentation in the displayed smart insights panel. The panel provider 728 can also perform usage tracking. For example, the panel provider 728 can retrieve state information 736 including the transaction identifier and the story identifier that was received in the response 732. The panel provider 728 can execute a record custom action method 738 that includes an indication of the open/expansion operation, the transaction identifier, and the story identifier.

The indication of the open/expansion operation, the transaction identifier, and the story identifier can be stored in a tracking repository 740. The information recorded in the tracking repository 740 can be used to update tracking metrics. For instance, a successful interaction with the acted-on insight can be recorded (e.g., when a rule specifies that expansion of the insight indicates success). As another example, a successful interaction with the invocation of the smart insights panel can be recorded (e.g., when a rule specifies that interaction with any displayed insight indicates a successful session with the smart insights panel).

In some implementations, success metrics are generated/updated in response to invocation of the record custom action method 738. In other implementations, success metrics are generated/updated after the smart insights panel is closed. For instance, at 742, the user 702 can perform a close user input to close the displayed smart insights panel. The smart insights panel class 714 can invoke a delete instance method 744 which can result in a delete usage tracker request 746 being sent to the smart insights usage tracker 710. The smart insights usage tracker 710 can generate and update success metrics, based on the information in the tracking repository 740, for example.

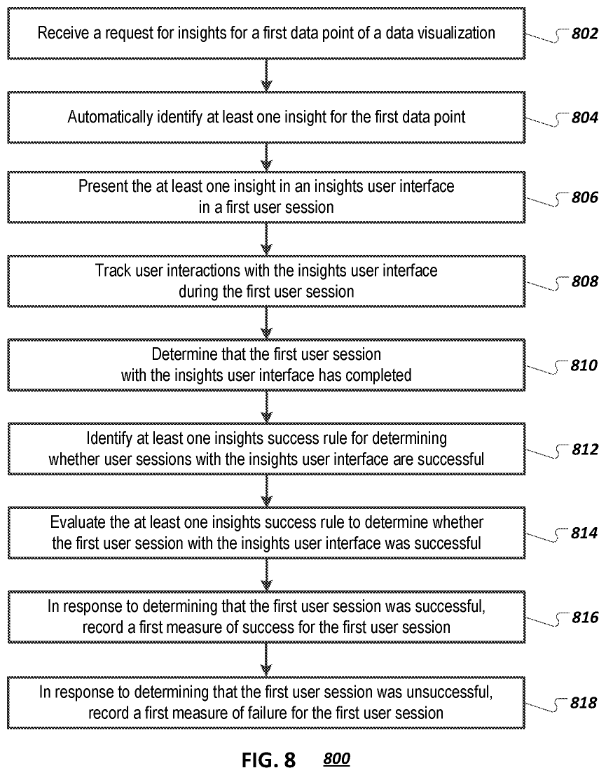

FIG. 8 is a flowchart of an example method for measuring successful interactions with an insight tool. It will be understood that method 800 and related methods may be performed, for example, by any suitable system, environment, software, and hardware, or a combination of systems, environments, software, and hardware, as appropriate. For example, one or more of a client, a server, or other computing device can be used to execute method 800 and related methods and obtain any data from the memory of a client, the server, or the other computing device. In some implementations, the method 800 and related methods are executed by one or more components of the system 100 described above with respect to FIG. 1. For example, the method 800 and related methods can be executed by the analytics platform 102 of FIG. 1.

At 802, a request is received for insights for a first data point of a data visualization.

At 804, at least one insight for the first data point is automatically identified. Insights can provide information for how a data point (or associated dimension) changes over time, or what other values most contributed to the data point.

At 806, the identified insight(s) are presented in a user interface in a first user session. A transaction identifier can be generated for the first session and mapped to interactions that occur during the first user session.

At 808, user interactions with the insights user interface are tracked during the first user session. User interactions with particular insights and with the insight user interface in general can be tracked. User interactions can include expanding insights, copying insights, or requesting subsequent insights for data points presented with first-displayed insights.

At 810, a determination is made that the first user session with the insights user interface has completed. For example, an indication of a closing of the insights user interface can be received.

At 812, at least one insights success rule for determining whether user sessions with the insights user interface are successful is identified. A first rule can specify that user sessions that include at least one interaction with at least one presented insight are successful. A second rule can specify that user sessions that do not include at least one interaction with at least one insight are unsuccessful. A third rule can specify action(s) on a particular insight of a first insight type that determine whether presentation of the insight of the first insight type is successful. In some implementations, different actions different weights, as reflected in rule(s), as far as resulting in a successful presentation of an insight or the insight tool itself.

At 814, the identified insights success rule(s) are evaluated to determine whether the first user session with the insights user interface was successful.

At 816, in response to determining that the first user session was successful, a first measure of success for the first user session is recorded. Measures of success can be recorded for particular insights and/or for the insight user interface in general. Recording a measure of success can include mapping the measure of success to the transaction identifier.

At 818, in response to determining that the first user session was unsuccessful, a first measure of failure for the first user session is recorded. Measures of failure can be recorded for particular insights and/or for the insight user interface in general. Recording a measure of failure can include mapping the measure of failure to the transaction identifier. Measures of failure (and measures of success) can be viewed by stakeholders of the insights user interface, such as in a usage tracking application or interface.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving a request for insights for a first data point of a data visualization;
automatically identifying at least one insight for the first data point;
presenting the at least one insight in an insights user interface in a first user session;
tracking user interactions with the insights user interface during the first user session;
determining that the first user session with the insights user interface has completed;
identifying at least one insights success rule for determining whether user sessions with the insights user interface are successful;
evaluating the at least one insights success rule to determine whether the first user session with the insights user interface was successful;
in response to determining that the first user session was successful, recording a first measure of success for the first user session; and
in response to determining that the first user session was unsuccessful, recording a first measure of failure for the first user session.

2. The method of claim 1, wherein a first rule specifies that user sessions that include at least one interaction with at least one presented insight are successful.

3. The method of claim 1, wherein a second rule specifies that user sessions that do not include at least one interaction with at least one insight are unsuccessful.

4. The method of claim 1, wherein determining that the first user session has completed comprises receiving an indication of a closing of the insights user interface.

5. The method of claim 4, further comprising recording the measure of failure when the closing has occurred without any interactions with any insights in the insights user interface.

6. The method of claim 1, wherein the tracking includes tracking interactions with the at least one insight.

7. The method of claim 6, wherein the at least one insights success rule includes a third rule for determining whether presentations of insights of a first insight type are successful.

8. The method of claim 7, wherein:
the tracking includes tracking interactions with a first insight of the first insight type;
evaluating the at least one insights rule comprises evaluating the second third rule with respect to the tracked interactions with the first insight; and
the method further comprises recording a second measure of success for the first insight type.

9. The method of claim 8, wherein interactions with the first insight include at least one of expanding the first insight, copying the first insight, or requesting insights for a data point presented with the first insight.

10. The method of claim 8, further comprising generating a transaction identifier for the first user session and wherein:
recording the first measure of success includes mapping the measure of success to the transaction identifier;
recording the first measure of failure includes mapping the first measure of failure to the transaction identifier; and
recording the second measure of success for the first insight type includes mapping the second measure of success to the transaction identifier and the first insight type.

11. The method of claim 8, further comprising presenting the first measure of success, the second measure of success, and the first measure of failure in a usage tracking application.

12. A system comprising:
one or more computers; and
a computer-readable medium coupled to the one or more computers having instructions stored thereon which, when executed by the one or more computers, cause the one or more computers to perform operations comprising:
receiving a request for insights for a first data point of a data visualization;
automatically identifying at least one insight for the first data point;
presenting the at least one insight in an insights user interface in a first user session;
tracking user interactions with the insights user interface during the first user session;
determining that the first user session with the insights user interface has completed;
identifying at least one insights success rule for determining whether user sessions with the insights user interface are successful;
evaluating the at least one insights success rule to determine whether the first user session with the insights user interface was successful;
in response to determining that the first user session was successful, recording a first measure of success for the first user session; and
in response to determining that the first user session was unsuccessful, recording a first measure of failure for the first user session.

13. The system of claim 12, wherein a first rule specifies that user sessions that include at least one interaction with at least one presented insight are successful.

14. The system of claim 12, wherein a second rule specifies that user sessions that do not include at least one interaction with at least one insight are unsuccessful.

15. The system of claim 12, wherein determining that the first user session has completed comprises receiving an indication of a closing of the insights user interface.

16. The system of claim 15, wherein the operations further comprise recording the measure of failure when the closing has occurred without any interactions with any insights in the insights user interface.

17. A computer program product encoded on a non-transitory storage medium, the product comprising non-transitory, computer readable instructions for causing one or more processors to perform operations comprising:
receiving a request for insights for a first data point of a data visualization;
automatically identifying at least one insight for the first data point;
presenting the at least one insight in an insights user interface in a first user session;
tracking user interactions with the insights user interface during the first user session;
determining that the first user session with the insights user interface has completed;
identifying at least one insights success rule for determining whether user sessions with the insights user interface are successful;
evaluating the at least one insights success rule to determine whether the first user session with the insights user interface was successful;
in response to determining that the first user session was successful, recording a first measure of success for the first user session; and
in response to determining that the first user session was unsuccessful, recording a first measure of failure for the first user session.

18. The computer program product of claim 17, wherein a first rule specifies that user sessions that include at least one interaction with at least one presented insight are successful.

19. The computer program product of claim 17, wherein a second rule specifies that user sessions that do not include at least one interaction with at least one insight are unsuccessful.

20. The computer program product of claim 17, wherein determining that the first user session has completed comprises receiving an indication of a closing of the insights user interface.
